(19) United States
(12) Patent Application Publication
(10) Pub. No.: US 2007/0222559 A1
(43) Pub. Date: Sep. 27, 2007

(54) Systems and Method for Delivery of Information

(75) Inventors: Stephanie H. Nickens, Mitchellville, MD (US); Walter F. Moleski, Laurel, MD (US); Corinne Irwin, Annapolis, MD (US); Julia Loftis, Annapolis, MD (US); Melissa Pell, Ellicott City, MD (US); Vince Pell, Ellicott City, MD (US)

Correspondence Address: NASA GODDARD SPACE FLIGHT CENTER, 8800 GREENBELT ROAD, MAIL CODE 140.1, GREENBELT, MD, 20771, US

(73) Assignee: NASA Headquarters, Washington, DC (US)

(21) Appl. No.: 11/561,337

(22) Filed: Nov. 17, 2006

Related U.S. Application Data
(60) Provisional application No. 60/740,296, filed on Nov. 17, 2005.

(51) Int. Cl. G08B 5/22

(52) U.S. Cl. 340/7.1

(57) ABSTRACT

A system and related methods are provided that notify affected persons of an alert message in a timely manner. In one embodiment, an authorized individual may first create an alert that is received by a central server. Next, the system may perform authentication to verify that the person creating the alert message has the authority to do so. If authorization is successful, the alert message may be stored in a database. The system may match the details of the alert message to user subscriptions. After determining who should be notified of the alert message, the system may determine the best way to notify the affected people. The notification mediums may be determined based on user information as well as the details of the alert message. The affected people may be notified via a secure transmission.

### ORIGIN OF THE INVENTION

This invention was made by employees of the United States Government and contractors operating under a contract with the United States Government, and thus may be used by or for the Government for governmental purposes without the payment of any royalties thereon or therefor.

### FIELD OF THE INVENTION

This invention relates generally to information delivery systems, and more particularly to a system capable of delivering emergency and time-sensitive alerts to affected individuals via a plurality of communications channels.

### BACKGROUND OF THE INVENTION

National and local security concerns, severe weather threats and emergency conditions are all motivating factors in creating a system that can deliver a timely alert or notification to a selected group. Thus, there are many such systems known in the art, for example, fire alarms, public address systems, televisions, radios, telephones and sirens. Each of these, however, can fall short in certain critical areas. By way of illustration, sirens and bells do not provide a clear description of the underlying cause for the alert. Also, televisions and radios have many weaknesses, including a dependency on the media and the fact that they may not be turned on or tuned in to the correct channel when the alert is made. Moreover, these systems may interrupt people who are unaffected by the alert. The following TABLE 1 provides a comparison of many of the available notification systems that are used to quickly disperse critical information to large groups of people.

TABLE 1

| Notification Medium | Strengths | Weaknesses |
|---|---|---|
| Television | Instant communication to all | Limited usefulness during |
| | affected people who are | many times of day- and |
| | watching. | especially in the late |
| | Gives detailed information, | evening/early morning if TV is |
| | and can keep people up to date. | turned off. |
| | Generally, universally | Limited usefulness outside of |
| | available (most people have a | the house. |
| | TV). | Will intrude upon people not |
| | | affected by the emergency. |
| | | Not available during power |
| | | outages. |
| | | Coordination among cable, |
| | | satellite, local stations, and |
| | | other media is required. |
| Radio | Instant notification to all | Limited usefulness during most |
| | affected people if tuned in. | times of day - and especially |
| | Gives detailed information and | in the late evening/early |
| | can keep people up to date. | morning if the radio is turned |
| | Generally, universally | off. |
| | available. | Will intrude upon people not |
| | Can work during power outage | affected by the emergency. |
| | with battery-operated radios | Must be tuned in to receive |
| | and can reach people inside | warning. |
| | their cars and outside of their | Those who are hearing- |
| | homes. | impaired will not receive the |
| | | alert. |
| Sirens | Instant notification if target is | Difficult to hear inside |
| | outdoors and within range. | buildings. |
| | If the population is educated to | Hearing-impaired will not |
| | different signals, it can also | recognize the alert. |
| | direct those alerted as to what | If the population is not |
| | actions to take. | educated to the meaning of the |
| | Will reach most people | sirens, they have little |
| | affected outdoors. | effectiveness. |
| | | Only targeted based on |
| | | location. |
| | | Unable to provide details |
| | | describing the emergency. |
| | | Disturbs those not affected. |
| Fire Alarms | Instant notification if target is | Need strobe light for those who |
| | indoors and within range. | are hearing-impaired to |
| | Works well if the alert is for | recognize the alert. |
| | people to evacuate. | Does not distinguish between |
| | | different types of alerts; alarms |
| | | only signal evacuation. |
| | | Unable to provide details about |
| | | the emergency. |
| | | Only targeted based on |
| | | location. Unaffected people |
| | | will receive the alert. |
| Public Announcement Systems — | Relatively quick message | Only a limited amount of |
| Loudspeakers | delivery. | information can be |
| | Can reach people indoors if | communicated. |
| | loud enough. | Cannot reach people who are |
| | Can be targeted to a subset of | hearing-impaired. |
| | people based on location only. | Message can be hard to hear |
| | Limited area can be reached | indoors. |
| | quickly. | Disturbs those not affected, |
| | | when announced to all in a |
| | | particular location. |
| Phone | Allows for strategic | If a large number of people |
| | notification. | need to be notified, dependent |
| | Universally available (most | on number of phone ports. |
| | people have a phone). | Person may not answer the |
| | Effective 24 hours a day. | phone. |
| | Relatively low cost. | Cell phone may not be |
| | Alert details can be | receptive. |
| | communicated. | Not available during telephone |
| | | outages. |
| | | Phone trees are typically used |
| | | which are sequential, take time |
| | | to execute, and can be |
| | | hampered by missing links. |
| Text Messaging Pagers | Allows for strategic | High cost for pagers. |
| | notification. | Person must have pager in |
| | Accessible to all if they are | possession and turned on. |
| | carrying an active pager and | Person may be situated in a |
| | pager is in a receptive location. | non-receptive location. |
| | Can supply limited information | Not normally usable by the |
| | regarding the emergency. | sight-impaired. |
| World Wide Web | Can supply text message with | Page must be section 508 |
| | substantial detail regarding the | compliant for those who are |
| | emergency. | sight-impaired to receive the |
| | | alert. |
| | | Recipient must manually go to |
| | | a page to receive the alert. |
| | | Not very fast alert dispatch. |
| | | Network dependent. |
| E-mail | E-mail can be sent out quickly. | Network dependent. |
| | E-mail can contain a text | Recipient has to be checking |
| | message. | E-mail at the time the |
| | | notification message is sent. |
| | | Not ideal for the sight- |
| | | impaired. |

As indicated, and as those skilled in the art will immediately recognize, there are many short-comings in conventional alert systems. Thus, there remains in the art a need for an alert system and associated methods that can be applicable to most any type of emergency situation, including fire and building evacuation, computer virus attack, power reduction, inclement weather, facility closing, road closing and construction, traffic congestion, and terrorist attack. Further, there is a need for a system that can provide the following high-level capabilities:
Specific groups of people can be notified immediately and simultaneously.

The notification can contain a description, severity level, optional instructions, and information on how to obtain further details.

Past notifications can be viewed at any time.

Only people affected by the alert can receive the notification.

The system can be fully accessible. Specifically, the system can be usable by everybody, including those with disabilities such as hearing and sight impairments. Furthermore, the system can be usable regardless of location and time-of-day.

The system can require very little maintenance.

The cost of the system can be reasonable and affordable.

### BRIEF DESCRIPTION OF THE INVENTION

The above-mentioned shortcomings, disadvantages and problems are addressed herein, which will be understood by reading and studying the following specification.

The current invention may include the ability to create and send an alert notification message using any number of mechanisms, including computers with network access, telephones, and even wireless devices such as a personal digital assistant (PDA).

Once an authorized person creates an alert, the system can be responsible for determining whom to notify and how to contact the affected people. There are numerous notification medium options that fall within the scope of this invention, including computers, E-mail messages, pagers, phones, and so forth. One skilled in the art will recognize that other medium options exist, and that those listed are given only by way of example.

The system infrastructure may be capable of utilizing the strengths of existing alert systems, augmented by other mechanisms such as desktop computer alerts. For example, if all people in a particular building need to be notified of critical information, then each person in the building can receive a computer desktop alert, the fire alarms in the building can sound, and the building closed circuit television network can display a video message and sound an audible message. By using multiple alerting mechanisms, the ability to contact people, including the hearing- and sight-impaired, at their computers, as well as within meeting rooms, bathrooms, and halls, may be enhanced.

In some embodiments, the system may include a computer-accessible medium having instructions capable of directing a processor to perform certain steps, including verifying an incoming alert message to be valid by verifying that the alert message was created by an authorized entity; determining a target audience to whom the alert message should be sent by categorizing the alert message by target audience, by location, by message type, and by alert severity; determining the best way to send the alert message to each member of the target audience by determining which message receivers are available to each member; and sending the alert message to each member of the target audience.

In some embodiments, a method of alert notification may comprise creating an alert message, and sending the alert message to a plurality of receivers such that the alert message overrides any preexisting data content displayed on the receivers. The method may include verifying that the alert message is valid by verifying that the alert message was created by an authorized entity. Further, the method may include categorizing the alert message by target audience, by location, by message type and/or by alert severity. The receivers may take any number of different forms, including, but not limited to, a desktop or portable computer, a cellular or hard-wired telephone, a personal digital assistant, or any other receiver device capable of providing a visual and/or audible alert. The alert message may be sent via secure transmission to ensure safe delivery to the intended parties.

In some embodiments, a target audience may be notified of an alert message in which the system verifies that the message is valid by authenticating the authority of the alert message creator before sending the alert message via secure transmission to a plurality of receivers, one or more of which may be wireless receivers. The method may further include matching details of the alert message to user subscriptions to determine the target audience and determining the best medium through which to notify each member of the target audience. In some embodiments, the system may be web-based.

### BRIEF DESCRIPTION OF THE DRAWINGS

FIG. 1 is a flowchart representing the logical flow of an alert through the system, according to an embodiment.

FIG. 2 is schematic representation of some of the major components of the system, according to an embodiment.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the invention. The following detailed description is, therefore, not to be taken in a limiting sense.

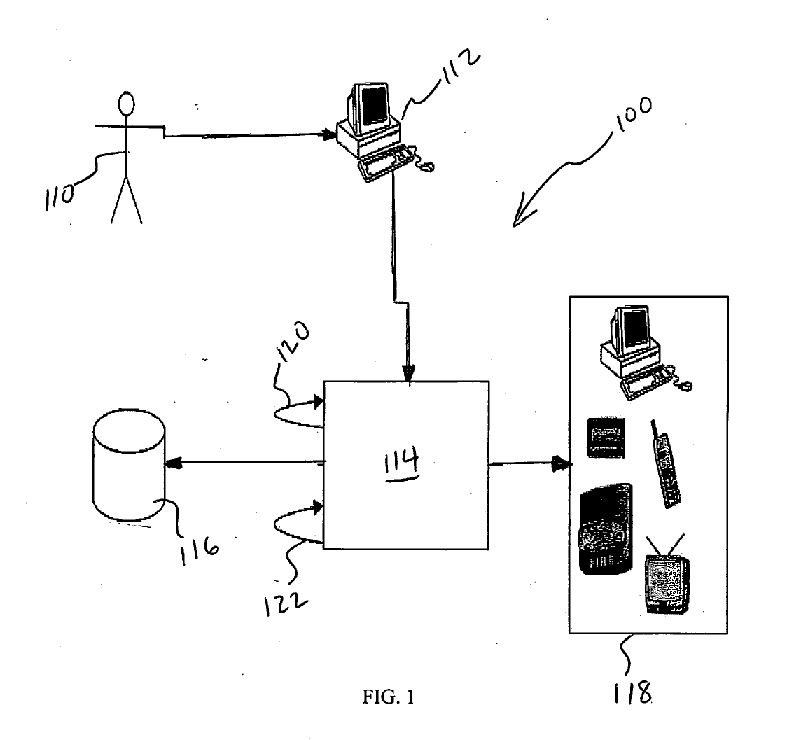

Referring now to FIG. 1, a logical flow of an alert message through the system 100 is depicted, according to an embodiment. First, an alert message creator 110 can initiate an alert message with a computer 112 or other suitable input device, which can then be received by a system server 114. The system 100 may then perform an authentication process 120 to verify that the alert message creator has the authority to do so. If authorization is successful, then the alert message may be stored in a database 116. The system 100 can then match the details of the alert message to user subscriptions on file in order to determine 122 who should receive the alert message and how such notification should take place. The notification mediums may be determined based on user information as well as the details of the alert message. At this point, actual notification of the affected persons can occur by sending the alert message to appropriate receivers 118. As indicated in FIG. 1, the receiver 118 may take the form of any number of different receivers, including by way of illustration but not by limitation, computers, PDAs, telephones, alarms and video monitors. In some embodiments, the system server 114 may not “push” the alert message to the receiver. The way in which the alert message is received can be based upon the receiver(s) used, which will be discussed hereafter.

In some embodiments, the system 100 can provide a flexible architecture to allow multiple mechanisms to create and submit an alert message, such as the world wide web, telephone, PDA, and existing systems such as those operated by the Federal Emergency Management Agency (FEMA) and the Centers for Disease Control (CDC). Since the system 100 is designed to handle many different types of alerts, from informational to critical to life-threatening, the system 100 may provide a way for an alert message creator 110 to classify the alert. The following kinds of information may be gathered and sorted to create an alert message.
Alert message creator information, including authentication details
Alert message class, such as campus-wide, weather alert, IT alert, facilities alert, etc.
Geographic information, such as country, state, county, facility, building
Severity of the alert message (critical, urgent, informational)

As indicated previously, the system 100 can be web-based and therefore one way to initiate an alert message may be to open a web browser and log in to the appropriate site. As one skilled in the art will appreciate, this may be accomplished through use of a computer or through use of other devices such as a wireless PDA or a web-enabled digital phone. Moreover, some embodiments of the system 100 may be capable of supporting the ability to receive a text message from a two-way text device to generate an alert message.

A large number of personnel at most any office sit at a computer to do much of their work during the day, so the computer can provide an excellent way to contact people quickly. One of the key benefits of notifying people via their desktops is the ability to require a person to acknowledge the alert. When an alert message is received from the system 100, a window may pop up in front of all the other windows on the user's desktop; that is, the alert message may override whatever the worker is working on at the time. The user may have to minimize or close the window in order to continue working. This quality may be advantageous for a notification system because users receive and must acknowledge a critical alert; whereas a TV or radio may be on the incorrect channel, and E-mail may be checked at the user's convenience.

Another powerful part of this notification medium may be the ability for subsets of people who are not geographically organized to receive alerts that affect them. Many alerts handled by the system 100 may not be geographically organized. For example, there may be a few categories of messages associated with IT resources around a particular office. A lower priority IT announcement explaining that particular servers will be unavailable due to maintenance upgrades will only affect people who access that server. The users of the servers may not be geographically grouped together; however, all the users would find this information very useful. In such a case, it may not make sense to ring the fire alarms or broadcast to all of the office across an office-wide network.

The system 100 may be configurable by the user so that each individual can designate how he or she would like to be notified based on the alert category and severity. For example, the most critical alerts messages may pop up a full size window on the desktop and play a sound. Other less critical alerts may play a less intrusive sound, a smaller window could pop up, or the system 100 tray icon may change color. The desktop application of the system 100 may be the most used and useful notification medium due to the flexibility described above.

However, there may also be some shortcomings for the desktop computer medium, including network and power outage vulnerabilities, as well as the fact that not everyone uses desktop computers on a regular basis. For such contingencies, some of the other alert mediums supported by the system 100, such as fire alarms, and alphanumeric paging, can be used during these situations to handle the most critical alerts.

In addition to receiving notifications, the system 100 may be capable of allowing the user to review older alerts. Perhaps the user was away from his/her desk, or just needs some details about an older alert, such as road closing dates or IT maintenance. The system 100 can open a web browser for the user to enter search criteria and view the details of earlier alerts.

Many large office campuses have an internal TV network that can provide an excellent way to communicate with personnel located in hallways, cafeterias, and other public areas. The system 100 can integrate with the internal TV network by providing a signal that conforms to requirements of the National Television Standards Committee (NTSC) and/or the Advanced Television Standards Committee (ATSC). In some embodiments, only the most critical alerts, such as building or campus evacuations would be broadcast using internal TV, since generation of the appropriate signal can be time consuming and unduly burdensome.

Many people, such as security and facilities personnel, can often be very mobile around an office campus. Text messaging via pager and digital phone can provide a convenient way to contact people who are not at their desks, in addition to those who are hearing-impaired. The system 100 can provide integration to send alert text messages to alphanumeric pagers and digital phones that support an E-mail gateway.

Some office campuses provide a centralized way to evacuate buildings through the use of existing fire alarms and strobes already wired around the campus. Often there is a centralized place through which the campus can contact outside emergency services such as police, fire, ambulance, and so forth. Frequently, a person monitors the dispatch center twenty-four hours a day, seven days a week. To integrate with this existing dispatch center, the system 100 can be installed on a computer(s) used by the people actively monitoring the dispatch center. Additionally, the person on duty could have a digital phone or alphanumeric pager registered with the system 100. When a critical alert that requires evacuation is received, the person on duty can receive the alert and be able to activate the fire alarms and strobe lights on a per building basis. Also, it may be possible to automate the activation of the fire alarms and strobes. Additionally, the system 100 may be to contact local authorities and emergency personnel automatically when appropriate.

The system 100 can provide support to notify people via E-mail. Some digital cell phones and PDAs can provide the ability to receive E-mail. The major weakness of notification via E-mail is the dependency on a user to read the E-mail. However, E-mail is very popular and most people have an E-mail account. This medium could be used to contact people at home with information such as campus closings.

One skilled in the art will readily recognize that, while a number of receiver mechanisms have been discussed herein, there are many others that could be used within the scope of this invention. For example, appropriate receivers for alert messages may further include, without limitation, light emitting diode (LED) moving signs and public announcement systems.

Notification rules can specify how a user wants to be notified of alerts based on category and severity. Some examples may include:
A user may wish to be notified via pager and computer desktop for critical alerts.
A user may wish to receive E-mail for all IT categorized alerts.
A user may wish to have the system 100 act differently based on alert category and severity. For critical alerts they may choose to have an obtrusive window pop up and play a sound. For informational alerts, a user may wish to have an operating system tray icon change color.

User subscriptions can provide users the ability to specify the alert categories they are interested in receiving alerts for. Below, TABLE 2 provides an outline of two example user category subscriptions.

TABLE 2

| Category | | |
|---|---|---|
| r represents a restricted | | |
| category | User A | User B |
| Office Campus | Critical | All |
| IT | Critical | Critical |
| Weather | | Critical |
| Facilities (road closings) | Critical | |
| Bldg. 24 | All | |
| IT r | | |
| Facilities r | All | |

TABLE 2 above presents two fictitious users, User A represents a large office campus facilities employee, and User B is any typical user. Not only can a user subscribe to a category, they can specify a severity interest level as well. For example, User A is interested in being notified of office campus alerts that are critical and is also interested in receiving all Bldg. 24 alerts. Furthermore, TABLE 2 above illustrates the notion of restricted categories. A restricted category may only be available to a selected subset of personnel. For example, the facilities, IT, and security personnel may wish to use the system 100 as an internal alerting system. Thus, if an operating system security patch has just been released, an internal IT employee may wish to alert other IT employees.

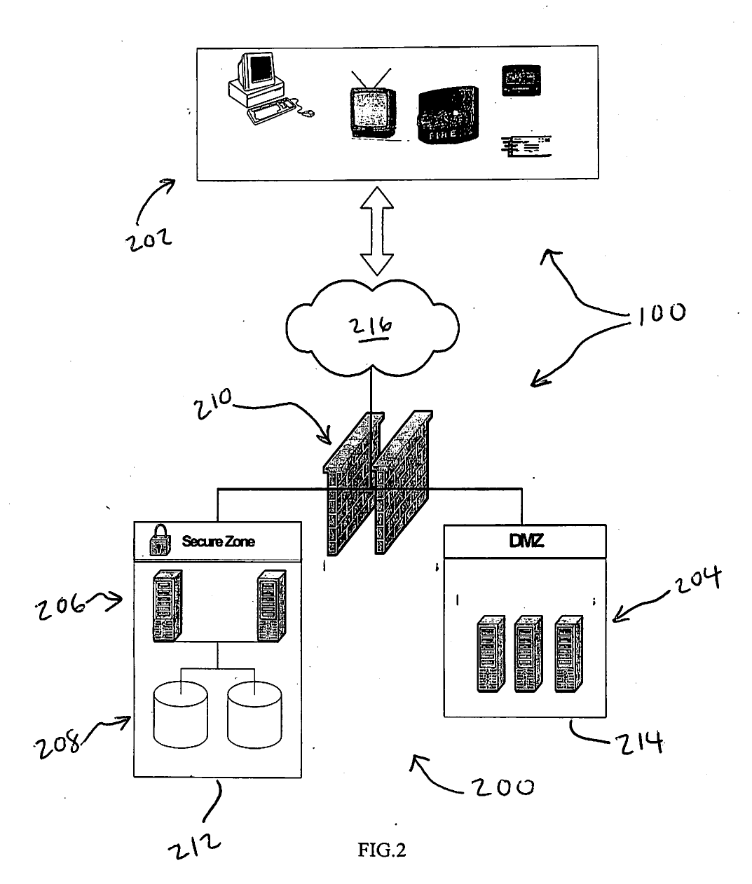

Referring now to FIG. 2, the system 100 is illustrated as a combination of a highly secure, highly available, centralized system 200 and a distributed system 202. The heart of the system 100 may be the central system 200, where alerts can originate, users and clients can be tracked, and notification recipients can be determined. Also, certain notifications can be handled at the central system level, such as E-mail, pagers, and phones. Many alert systems, such as closed circuit television, fire alarms, and LED displays, exist already and cannot easily be physically moved to the central system 200. In addition, desktop users across the campus may need to be notified. The system 100 may provide a secure, reliable mechanism for notifying these remote systems.

As indicated, in some embodiments, the central system 200 may be the core of the system 100. Users can connect to the central system 200 to indicate what alerts they are interested in, and all user and other client information can be stored at the central system 200. All alerts may be entered through the central system 200 via several possible mechanisms. Once alerts are entered, the system can determine which users and clients need to be notified, and perform the notification.

The central system 200 can be broken into several logical parts. The system 200 may include a bank of web servers 204 for handling all internet traffic. The web servers 204 can deliver the web pages for all the web applications (such as sending an alert). The application servers 206 can sit behind the web servers, perform all system 100 computing, and initiate all action in the system 100. A database 208 can store all user profile and alert configuration data. In at least one embodiment, all parts of the central system 200 may be replicated so that any component machine can go down without debilitating the whole system.

A firewall 210 can be the first line of security for the central system 200, as all internet communication to the central system 200 may be required to pass through the firewall. The firewall 210 can divide the central system 200 into two areas, as shown in FIG. 2. The first can be a “super-secure” area 212, where all data can reside and all processing can take place, and the second can be a slightly less secure area 214, which can be called a DMZ (as in de-militarized zone).

The firewall 210 may prevent any computer from coming in off the Internet 216 to access a machine in the secure area, making it impossible to hack directly into any secure machines. The database 208 and application servers 206 may be put in the super-secure area 212. The firewall 210 can allow computers connected to the internet 216 to access machines in the DMZ 214, and the web servers 204 can reside there to communicate with the outside world. Machines in the DMZ 214 can be allowed to communicate with the secure area. The firewall 210 can also places restrictions on what type of communications can occur. The firewall 210 can allow HTTP access, a relatively safe protocol, to the DMZ 214 from the Internet 216, but can prevent access through more dangerous protocols like FTP or telnet. This strict protection at the network level may remove many security threats that exist in the server machines' operating systems and applications.

In some embodiments, the bank of web servers 204 may be running Apache HTTP servers to communicate with the outside world. These servers can host all web applications, including the web interface for users to set up what alerts they are interested in and the web interface for generating an alert. The other interfaces (desktop application, cell phone, PDA) can also communicate through the web servers 204, but may use web services and WML (wireless markup language) rather than web pages. Clients who may poll the central system 200 for alerts can communicate with the web servers 204 using HTTP. When the web servers 204 need to perform actions, they can communicate with the application servers using HTTP.

The application servers 206 may be responsible for all processing in the system. They may be running a replicated JBoss EJB server, although one skilled in the art will notice that other servers may be used without departing from the scope of the invention. The application servers 206 may provide all logic behind the web applications. They can receive user actions from the web servers 204, analyze the actions, determine responses, generate the appropriate web pages, and return the web pages to the web servers 204, to be then sent to the users. When cell phones or PDA's connect, it may be the same process, only the phones and PDA's may use WAP (wireless application protocol) to connect, and the application servers 206 can generate WML pages. When a desktop client connects, it may use SOAP, which is a protocol that passes XML (extensible markup language) over HTTP, although other protocols may be used. The application servers 206 may generate XML to return to the desktop client.

When an alert comes in, the application servers 206 may determine which clients need to be notified and then notify them. The E-mail and paging notifications can be done with an E-mail server running on the application servers 206. If automated phone calls are made, the application servers can use special software and hardware to interface with phone lines. The application servers 206 can directly notify any desktop clients that are not behind firewalls. They may also notify the web servers 204 of a new alert for the desktop clients behind firewalls.

In some embodiments, all user profile information may be kept on the central system 200. This can allow users to move from computer to computer or away from any computer and still receive alerts. The database 208 can store all users' accounts, what alerts they are subscribed to receive, and how they prefer to be notified. The database 208 can also hold a registry of which client applications are currently registered and online. The application servers 206 can access the database 208 to store and retrieve this information. In some embodiments, the database 208 may run a replicated Postgres database.

The desktop client can be the main medium by which people who work at computers will be notified. When a user logs in, the system 100 can connect to the central system 200 and register the user as online. It may also automatically subscribe to any alerts specific to the building or floor where the computer resides. Whenever an alert is created, the central system 200 may determine if that user should be notified of a particular alert, and if so, notifies the desktop client.

The desktop client may be capable of signaling an alert in several ways, ranging from unobtrusive (e.g., appearing as a specific symbol in the operating system tray) to unavoidable (e.g., appearing in a pop-up window that obscures the entire computer screen). The pop-up window may not destroy anything the user is currently working on when the alert is received.

In some embodiments, all communication with the central system 200 may be over a secure internet connection. Digital certificates can be used to ensure that the desktop client is connecting with the central system 200 and not a malicious entity pretending to be the central system, and encryption can be used to prevent malicious entities from modifying the communication content.

When the desktop client first registers with the central system 200, it may test whether it can connect to the desktop, or if a firewall or address translation may be preventing access. If it can connect, the client may need only to send periodic reregisters on the order of every hour to ensure that it is still running. When an alert comes in, the central system 200 may contact the client and deliver the alert. If the central system 200 cannot connect, the desktop client may need to periodically connect to the central system 200 to ask if any new information has arrived. This can be called polling. The clients may poll the central system 200 on the order of every minute to check if there are any alerts that the client needs to know about.

All clients, including the desktop client, may be able to connect to more than one central system 200. The desktop clients can run on all operating systems, including, but not limited to, Linux, Mac OSX, Sun Solaris, HP HPUX, and SGI Irix.

The system 100 can be designed to be working around the clock and never exhibit failure or overly degraded performance. This may be accomplished by having multiple instances of every component machine. Running modules of the system on multiple machines can protect the system 100 from machine failure, enable machine maintenance, and allow the system 100 to handle higher peak loads.

In some embodiments, every part of the central system 200 described above (firewall 210, web servers 204, application servers 206, and database 208) may have replicated software running on multiple machines. Replicated software can mean that the software running is aware of the other instances and will share state information, so that if one machine goes down, the other can take over without loss of state or data. If any machine should fail, the system 100 can continue to operate, though perhaps not with the same peak performance. This feature also may allow for machines to be taken offline to upgrade system software and operating systems, which can be a cheaper option than using software that can be upgraded while still running.

In at least one embodiment, the dominant load on the system may be the polling and reregistering of desktop clients. A peak load may occur when an alert needs to be sent to all desktop clients.

### CONCLUSION

A system and attendant methods of alert notification are described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations.

In particular, one of skill in the art will readily appreciate that the names of the methods and system are not intended to limit embodiments. Furthermore, additional methods and systems can be added, functions can be rearranged among the described components, new components can be added to correspond to future enhancements, and physical devices used in embodiments can be introduced without departing from the scope of embodiments. One of skill in the art will readily recognize that embodiments are applicable to future communication devices, different file systems, and new data types.

The terminology used in this application is meant to include all versions of and any new communication environments and alternate technologies which provide the same functionality as described herein.

We claim:

1. A method of alert notification comprising:
a) creating an alert message, and
b) sending the alert message to a plurality of receivers, wherein the alert message overrides any preexisting data content displayed on the receivers.

2. The method of alert notification of claim 1, further comprising verifying that the alert message is valid.

3. The method of alert notification of claim 2, wherein verifying that the alert message is valid includes verifying that the alert message was created by an authorized entity.

4. The method of alert notification of claim 1, further comprising categorizing the alert message.

5. The method of alert notification of claim 4, wherein the alert message is categorized by target audience.

6. The method of alert notification of claim 4, wherein the alert message is categorized by location.

7. The method of alert notification of claim 4, wherein the alert message is categorized by message type.

8. The method of alert notification of claim 4, wherein the alert message is categorized by alert severity.

9. The method of alert notification of claim 1, further comprising saving the alert message to a database for future use.

10. The method of alert notification of claim 1, wherein at least one of the receivers is a desktop computer.

11. The method of alert notification of claim 1, wherein at least one of the receivers is a telephone.

12. The method of alert notification of claim 11, wherein at least one of the telephones is a cellular phone.

13. The method of alert notification of claim 1, wherein at least one of the receivers is a personal digital assistant.

14. The method of alert notification of claim 1, wherein at least one of the receivers includes means for audibly delivering the alert message.

15. The method of alert notification of claim 1, wherein at least one of the receivers includes means for visually displaying the alert message.

16. The method of alert notification of claim 1, wherein sending the alert message to a plurality of receivers is accomplished via secure transmission.

17. A method of notifying a target audience to an alert message originated by an alert message creator comprising:
a) verifying that the alert message is valid by authenticating the authority of the alert message creator, and
b) sending the alert message via secure transmission to a plurality of receivers.

18. A method of notifying a target audience to an alert message originated by an alert message creator, according to the limitations of claim 17, wherein at least one of the receivers is a wireless receiver.

19. A method of notifying a target audience to an alert message originated by an alert message creator, according to the limitations of claim 17, further comprising matching details of the alert message to user subscriptions to determine a target audience.

20. A method of notifying a target audience to an alert message originated by an alert message creator, according to the limitations of claim 19, further comprising determining the best medium to notify the target audience.

21. A method of notifying a target audience to an alert message originated by an alert message creator, according to the limitations of claim 17, wherein the alert message overrides any preexisting data content displayed on the receivers.

22. A method of notifying a target audience to an alert message originated by an alert message creator, according to the limitations of claim 17, wherein the alert message is sent to the plurality of receivers via the world wide web.

23. A computer-accessible medium having executable instructions to generate a system, the executable instructions capable of directing a processor to perform:
a) verifying an alert message to be valid,
b) determining a target audience to whom the alert message should be sent,
c) determining the best way to send the alert message to each of the target audience, and
d) sending the alert message to each of the target audience.

24. The computer accessible medium of claim 23, the executable instructions further comprising saving the alert message to a database for future use.

25. The computer accessible medium of claim 23, wherein the executable instructions capable of directing a processor to perform determining a target audience to whom the alert message should be sent includes categorizing the alert message by at least one of target audience, location, message type, and alert severity.

26. The computer accessible medium of claim 23, wherein the alert message is received by each of the target audience on a receiver such that the alert message overrides any preexisting data content displayed on the receivers.
